(19) United States
(12) Patent Application Publication
(10) Pub. No.: US 2005/0255855 A1
(43) Pub. Date: Nov. 17, 2005

(54) Locating mobile terminals

(75) Inventors: Maurizio A. Spirito, Torino (IT); Eero Sillasto, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/030,905

(22) Filed: Jan. 10, 2005

(30) Foreign Application Priority Data
May 12, 2004 (GB) GB 0410610.0

(51) Int. Cl. H04Q 7/20

(52) U.S. Cl. 455/456.1

(57) ABSTRACT

A method of generating a location estimate for a mobile station in a wireless communications network. The method includes receiving first measurement data relating to at least one radio link between the mobile station and a first site and using said first measurement data in a location calculation method with radio network data to provide a first preliminary location estimate. The method also includes receiving second measurement data relating to at least one radio link between the mobile station and a second site and using in the location calculation method with radio network data to provide a second preliminary location estimate. The method further includes determining the location estimate as the weighted mass center of the first and second preliminary location estimates.

### FIELD OF THE INVENTION

The present invention relates to a method and an apparatus for locating a mobile terminal in a communications network, particularly but not exclusively using multiple sources of information.

### BACKGROUND OF THE INVENTION

The ability to pinpoint the location of mobile terminals is a desirable feature of a mobile telephone network. This is because of the need to provide customer services which rely on knowing the whereabouts of users of these services. For example, up-to-date local traffic information can be provided to enable a user to avoid nearby traffic jams. A user may also wish to know, for example, how to get to the nearest pub or restaurant from their present location. Clearly the location of the user must be ascertained to within even a few metres for this type of service to work.

Another reason for wishing to know the location of a mobile terminal is so that emergency services can locate a caller who is unable to provide an accurate personal location themselves.

It is known in a GSM mobile network to provide the location of a mobile telephone in terms of the cell of the network in which the telephone is located. Each cell contains one base station and a telephone is only ever in traffic communication with one base station at a given time. Hence the location of the telephone to an accuracy of the cell area can be determined simply by ascertaining with which base station the telephone is communicating. Such methods are known as cell-based location methods. Other methods can be combined with the cell identity (CI), such as a triangulation system, in which the location of a particular mobile phone is calculated using control signals from at least the three base stations closest to it (two of which are located in adjacent cells to the cell in which the mobile telephone is located). This system uses the assumption that the distance of the phone from a base station is proportional to the strength of the signal which the base station receives from it, or the time taken for the signal to travel between the phone and the respective base station. Thus the position of the phone can be determined by comparing the relative strengths or travel times of received signals between the three base stations and thus assessing the distance of the user from each base station. The actual location of the user is then obtainable geometrically since the location of the base stations is known and fixed.

In a 3GPP (3^{rd} Generation Partnership Project) network using a Wideband Code Division Multiple Access (W-CDMA) signalling system, it is possible for a mobile terminal to be in active communication with more than one base station at any one time. This situation is known as “soft handover” and differs from (hard) handover in a GSM system, in which a mobile terminal is “handed over” from one base station to another as it moves between cells of the network. Because of the nature of the soft handover, the above-described cell-based mobile location procedures suitable for GSM can not always be used in a W-CDMA type signalling system. It has therefore been necessary to develop more reliable ways of locating a mobile terminal in this type of signalling system.

In W-CDMA a “softer handover” is defined as well. In the case of “softer handover” the antennas of the base stations with which the mobile station is communicating are co-located (e.g. they are installed at the same physical location or site). In the remainder of this document, the term “soft handover” will be used also to cover the case of “softer handover”, and it will be understood by those skilled in the art that the invention and the described embodiments thereof are applicable to a softer handover situation as well as a soft handover situation.

Location techniques are known which are directed towards calculation of a location estimate and a “confidence region” associated with the location estimate of a User Equipment (UE).

One such technique is a Cell Identity and Round Trip Time (CI+RTT) location method.

The CI+RTT location method in UMTS relies on the availability of Round Trip Time (RTT) and Rx−Tx Time Difference (RxTxTD) measurements. RTT and RxTxTD measurements are introduced in UMTS FDD (Frequency Division Duplex) to allow the implementation of the CI+RTT location method.

The RTT is defined as RTT=T_{RX}^{UL}−T_{TX}^{DL}, where TD_{TX}^{DL} is the time of transmission of the beginning of a downlink dedicated physical channel (DPCH) frame to a User Equipment (UE) and T_{RX}^{UL} is the time of reception of the beginning (the first detected path, in time) of the corresponding uplink DPCCH (Dedicated Physical Control Channel)/DPDCH (Dedicated Physical Data Channel) frame from the UE.

The RTxTxTD=T_{TX}^{UL}−T_{RX}^{DL} is the difference in time between the UE uplink DPCCH/DPDCH frame transmission (T_{TX}^{UL}) and the first detected path (in time) of the downlink DPCH frame from the measured radio link (T_{Rx}^{DL}).

RTTs are measured by the base stations, RxTxTDs are measured by the UE.

By combining a pair of RTT and RxTxTD measurements referred to the same base station the distance between the UE and that base station can be estimated. Such distance estimate is analogous to the distance estimate that can be obtained from one Timing Advance (TA) in GSM. In this sense, the CI+RTT location method corresponds to the Cell Identity+Timing Advance (CI+TA) location method in GSM. However, two particular features of UMTS FDD make the CI+RTT method potentially more accurate than the Cl+TA method in GSM:
1. The much shorter UMTS chip period as compared to the GSM bit period affects the resolution with which a distance estimate can be determined from a TA in GSM or from an (RTT, RxTxTD) pair in UMTS. One GSM bit period is equivalent to approximately 1100 meters while one UMTS chip period is equivalent to approximately 80 meters, thus the distance measurements resolution in UMTS is better than in GSM.
2. In UMTS a UE can be in soft handover. UMTS standards require that RTTs and RxTxTDs are measured for each active radio link, thus multiple distance estimates can be potentially available for locating one UE in UMTS. In GSM this is not possible since the TA is available only for the unique serving cell.

In the CI+RTT location method the unknown geographical coordinates of the UE whose position it is desired to determine are estimated by combining absolute distance measurements between the UE and the base stations in the active set. Each absolute distance measurement is calculated from each (RTT, RxTxTD) pair.

Existing CI+RTT location methods can be considered to fall broadly into two general categories, single-site location methods and multi-site location methods. There are a number of good, reasonably accurate algorithms for implementing multi-site location methods when the UE have active radio links with cells located at three or more sites. However, such methods often fail when two or less sites are available for location calculation purposes.

The need for limiting the number of active radio links allocated to a W-CDMA UE (to limit network load) makes the likelihood of calculating a location estimate using only two sites much higher than the likelihood of having three or more sites available for calculating it. Therefore, there is a real need for a location method which is capable of providing a good estimate of the UE location when only two sites are available.

It is noted herein that although the location methods which are discussed are particularly valuable in a situation where there are less than three sites available, they can of course be used in a situation with three or more sites as well.

### SUMMARY OF THE INVENTION

According to one aspect of the invention there is provided a method of generating a location estimate for a mobile station in a wireless communications network, the method comprising: receiving first measurement data relating to at least one radio link between the mobile station and a first site and using said first measurement data in a location calculation method with radio network data to provide a first preliminary location estimate; receiving second measurement data relating to at least one radio link between the mobile station and a second site and using in the location calculation method with radio network data to provide a second preliminary location estimate; determining the location estimate as the weighted mass centre of the first and second preliminary location estimates.

A further aspect of the invention provides in a cellular communications network, a network entity adapted to generate a location estimate for a mobile station in the network, the network entity comprising: means for implementing a location calculation method using measurement data relating to radio links between the mobile station and respective first and second sites and radio network data to provide respective first and second preliminary location estimates; and means for determining the location estimate as the weighted mass centre of the first and second preliminary location estimates.

In the preferred embodiment, the steps of providing the first and second preliminary location estimates comprise generating first and second respective distance estimates of the distance between the mobile station from the first and second site respectively.

According to a first technique, where the first site supports a plurality of cells, the first measurement data relates to radio links of at least two of said cells and a single first distance estimate is generated using the first measurement data of the two radio links.

In a second technique, where the first site supports at least first and second located cells, the first measurement data relates to a first radio link from the first cell, and further measurement data is provided which relates to a second link from the second cell. In that case, a further preliminary location estimate is generated which is used with the first and second preliminary location estimates to generate the weighted mass centre of the location estimate of the mobile station. In this case, respective first, second and further distance estimates are preferably generated in the step of providing the first, second and further preliminary location estimates respectively.

It will be appreciated that there may be more than two cells with established radio links per site.

For a better understanding of the present invention and to show how the same may be carried into effect, reference will now be made to the accompanying drawings.

### BRIEF DESCRIPTION OF THE DRAWINGS

FIG. 1 is a schematic block diagram of distance estimation equipment;

FIG. 2 is a diagram illustrating RTT and TD;

FIG. 3 is a sketch of part of a cellular communications network;

FIG. 4 is a schematic diagram of a WSS location method;

FIG. 5 is a schematic diagram of a WSC location method;

FIG. 6 is a schematic block diagram of equipment for implementing a CI+RTT location method;

FIG. 7 shows an arc-shaped confidence region; and

FIG. 8 is a schematic diagram of the architecture of a network.

### DESCRIPTION OF THE PREFERRED EMBODIMENTS

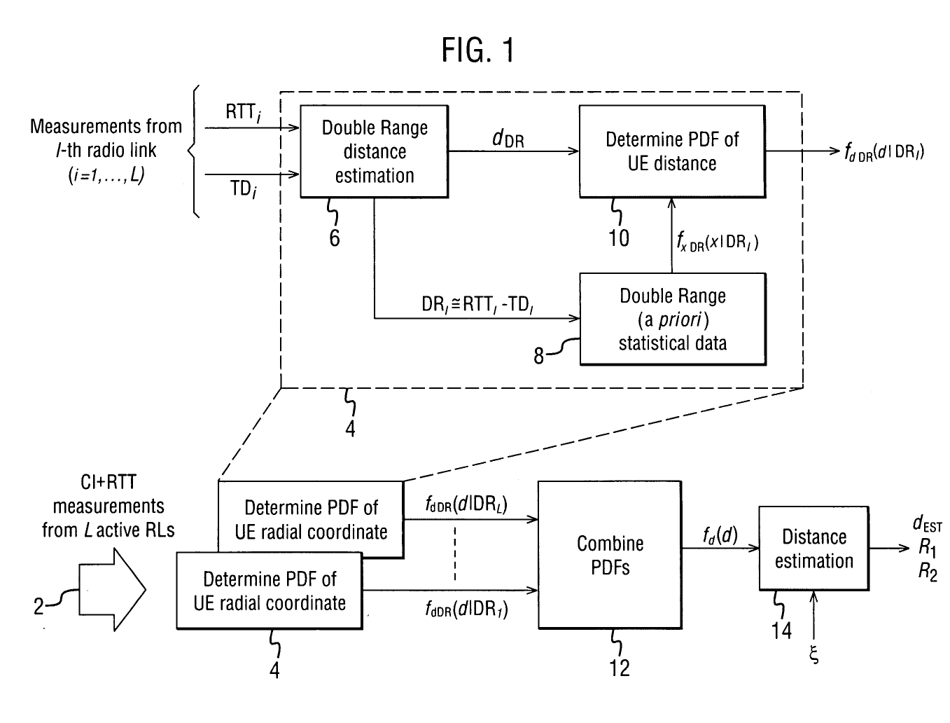

Before describing methods in accordance with embodiments of the present invention, a detailed description of one possibility for calculating a distance estimate will firstly be described with reference to FIG. 1, because this is an important component of the location methods discussed in the following. It will be appreciated however that other distance estimation techniques could be used.

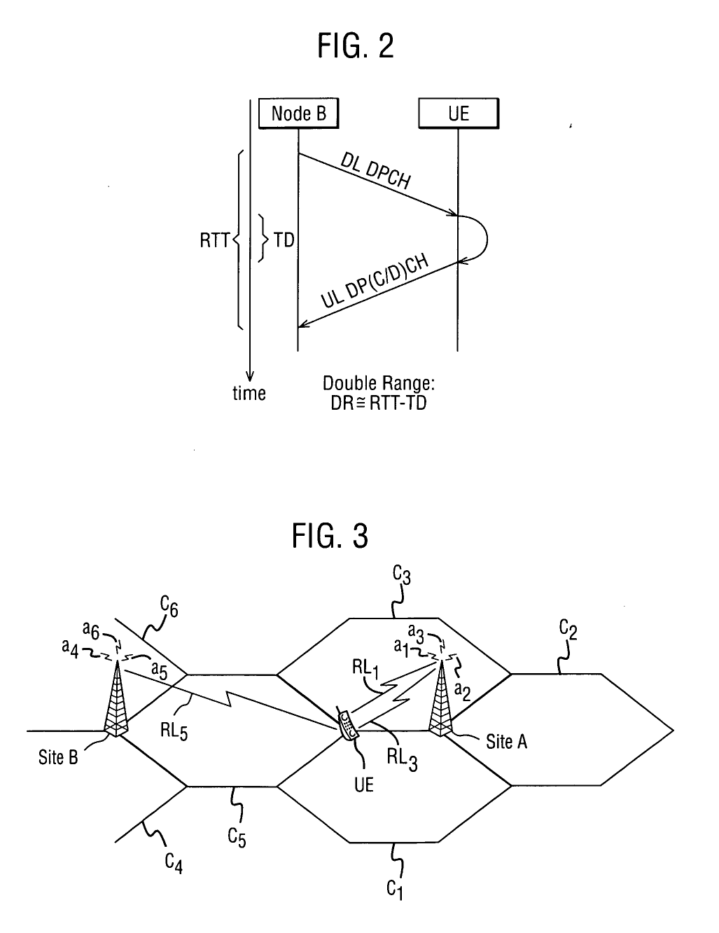

FIG. 1 is a schematic block diagram illustrating the blocks involved in a distance estimate calculation obtained from a set of measurement pairs of the round trip time (RTT) and Rx−Tx time difference (TD). FIG. 2 illustrates what these distances represent in a mobile communications network. FIG. 2 illustrates a user equipment UE which can be in the form of a mobile telephone or other mobile terminal and a Node B, which represents a base station in the universal telecommunications radio access network (UTRAN) system. A downlink dedicated physical channel signal labelled DL DPCH in FIG. 2 dispatched from node B takes a certain amount of time to reach the user equipment UE. There is a time delay TD at the user equipment before an uplink response to the downlink signal is returned from the user equipment to Node B. This response is labelled ULDP(C/D)CH in FIG. 2. The total circuit time measured from dispatch of the downlink signal to receipt of the corresponding uplink signal is the round trip time RTT. That is, it represents the difference between the time of transmission of the beginning of a downlink dedicated physical channel (DPCH) frame to a user equipment UE and the time of reception of the beginning of the corresponding uplink UL dedicated physical control channel (DPCCH)/dedicated physical data channel (DPDCH) frame from the user equipment.

The time difference TD is, as explained, the difference in time between the uplink ULDPCCH/DPDCH frame transmission and the first detected part of the downlink DPCH frame. This delay is in a typical case nominally equal to 1024 chip periods. A measurement pair of RTTᵢ, TDᵢ values is supplied to the distance estimation equipment from each i-th active radio link in the mobile communications network. The manner in which measurements for co-located cells (that is cells served from the same site) are dealt with differs depending on the location method which is to be implemented, as will become clear in the following. For the purpose of describing FIG. 1, it is assumed that one distance estimate is obtained from a set of RTT, TD measurement pairs measured from active radio links supplied by co-located cells.

The measurement pairs are denoted by arrow 2 in FIG. 1, each pair being supplied to a respective probability function determination block 4. Each probability determination block 4 comprises a double range distance estimation calculator 6 which calculates a double range distance estimate d_{DR} from each RTT and TD measurement pair. d_{DR} is an estimate expressed in metres of the distance between the user equipment and the location of node B at the site of the serving cell. It is calculated by converting into metres an integer number, the so-called double range (DR) which is obtained by removing the TD value contribution from the RTT value. A statistical data block 8 holds a priori statistical data that has been gathered which gives an estimate of the likely measurement error in the double range distance estimate. That is, given the exact distance between the user equipment UE and the serving cell, d, it is possible to calculate the double range measurement error, x=d−d_{DR}. Such an error can arise as a result of several factors: multipath and non-line of sight propagation, measurement algorithms inaccuracy, granularity introduced by the measurements finite resolution, etc. By premeasuring data of this kind, a probability density function of the double range measurement area can be determined and this is supplied to a PDF determination (probability density function determination) block 10 which combines the PDF of DR measurement error f_{x|DR}(x|DR) with the DR distance estimate d_{DR}, to obtain the PDF of the UE distance from each co-located serving cell f_{d|DR}(d|DR)=f_{x|DR}(x=d−d_{DR}|DR).

The probability density functions of the distance from all the co-located serving cells is then combined into one probability density function, f_{d}(d) representing the probability density function of the distance of the user equipment UE from the site where all the serving cells' antennas are installed. This is carried out in the combine PDF block 12. Once the combined PDF is available, the distance estimation is performed in the distance estimation block 14. The result of the distance estimation is represented by three values:
a distance estimate, d_{EST}μ0
an inner radius, 0[R₁[d_{EST}
an uncertainty radius, R₂μ0

The distance estimate d_{EST} is calculated as the median of the combined distance distribution from the PDFs. The inner and uncertainty radii define a confidence interval [R₁,R₁+R₂] within which the exact distance d of the user equipment UE is estimated to fall with a predefined confidence coefficient, [symbol] . The value of the confidence coefficient depends on the target confidence level requested by the user of the location algorithm, and is input into the distance estimation block 14 as shown in FIG. 1.

A description of a technique for estimating the location of a user equipment UE in accordance with a first embodiment of the invention will now be described. FIG. 3 illustrates the physical situation in which this method may be used. The method is referred to herein as a weighted single site (WSS) method.

FIG. 3 represents part of a cellular communications network illustrating a first base station at Site A and a second base station at Site B. Each base station serves three cells with accordingly oriented antennas. The cells are labelled C₁, C₂ etc and the antennas are labelled a₁, a₂ etc. The orientation of the antennas at each site is known, and the assumption is made that the cell identity CI provides network data including for example antenna orientation data. A user equipment UE is shown in softer handover at Site A, that is with a first radio link RL₁ established with antenna 1, and a second radio link RL₃ established with antenna 3. The user equipment UE also has a radio link RL₅ established with antenna 5 of the base station at Site B.

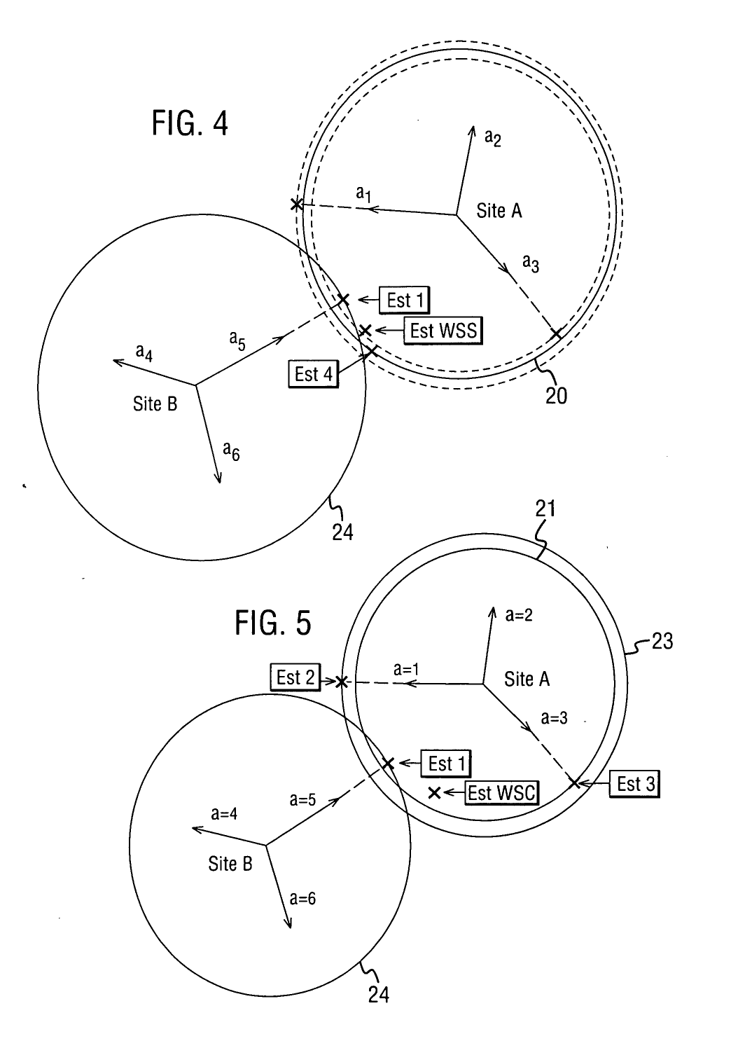

FIG. 4 is a schematic diagram illustrating how a location estimate can be obtained using the WSS method in this situation. A first estimated location which is labelled Est 4 in FIG. 4 is obtained in the following way. RTT, TD pairs from each of the radio links RL₁ and RL₃ are combined in the distance estimation equipment illustrated in FIG. 1 and an estimated distance d_{EST} is produced, which represents the radius of the circle which is shown in full and labelled 20 in FIG. 4. Note that the dotted circles just inside and outside circle 20 represents different measurements for the estimated distance, which will be discussed more fully in relation to the second embodiment discussed below.

A preliminary single site CI+RTT location estimate is obtained using the distance estimate obtained using the technique described above with reference to FIG. 1 and an angular estimation arrived at using a single site CI+RTT location based on the network data from the CI. An “averaged” orientation of the two antennas generating the radio links, in this case a₁ and a₃ is produced. Each preliminary location estimate is calculated in a polar reference system centred at each cell's site, using the single site CI+RTT method discussed later. The first location estimate Est 4 can thus be seen to lie at a distance d_{EST4} along an averaged orientation of the antennas a₁, a₃. It will readily be appreciated that the orientation value which is used, being based on an average of the two antennas' orientation is a simple but primitive measurement. If more accurate orientation information relating to the user equipment UE is available, that could also be used to determine the first location estimate Est 4.

A second location estimate is obtained for Site B, in this case applying a single RTT, TD measurement pair to the distance estimation equipment of FIG. 1 and generating an estimated distance d_{EST1} which in this case represents the radius of the circle denoted 24 in FIG. 4. Note that when a single RTT, TD pair is input into the distance estimation equipment of FIG. 1, there is no need to perform the combined PDF step of block 12, because only a single PDF is determined which is supplied directly to the distance estimation block 14. In this case, there is a single radio link RL5 and so the location estimate which is labelled Est 1 in FIG. 4 is generated by taking the estimated distance d_{EST1} with the orientation of that antenna a₅, is the simplest case. Again, the angular estimation for the antenna orientation can be generated using the single site CI+RTT location method.

The final location estimate which is labelled EST WSS is obtained as the weighted mass centre of the preliminary location estimates, Est 1, Est 4. That is, the coordinates of the preliminary location estimate are taken (on a polar or Cartesian reference frame), weighted and then averaged.

In a Cartesian reference system, an algorithm which can be used in embodiments of the present invention to obtain the estimated x (and respectively, y) UE coordinates as a weighted average of the x (and respectively, y) site coordinates, the signal of which is received by the MS is given below:

$$\hat{x} = \frac{{\sum }_{i = 1}^{N} {w}^{i} {x}^{i}}{{\sum }_{i = 1}^{N} {w}^{i}} ; \hat{y} = \frac{{\sum }_{i = 1}^{N} {w}^{i} {y}^{i}}{{\sum }_{i = 1}^{N} {w}^{i}} ; ( \hat{x} , \hat{y} ) ∈ D$$

where w¹, . . . ,w^{N} are suitable weights assigned to each one of the N estimates involved, \hat{x},ŷ are the coordinates of the final estimate and xiⁱ, yⁱ are the coordinates of each preliminary location estimate.

One suitable definition for the i-th weight used in embodiments of the present invention is to use the inverse of the estimated distance, d_{ESTi} associated with each preliminary location estimate:

$${w}^{i} = \frac{1}{{d}_{ESTi}}$$

An alternative is to apply constant weights for all cells. A further alternative is to use weights equal to the inverse of the area of an arc-shaped confidence region which is determined as a by-product to the preliminary single site CI+RTT location calculation (discussed later). Another possible criterion for determining the weights is to assign heigher weights to preliminary location estimates which are believed to originate from more accurate distance measurements.

A location method according to a second embodiment will now be described with reference to FIG. 5, referred to as Weighted Single Cell (WSC) method. This method is similar to the method of the first embodiment, the main difference between the two consisting in the way that measurements from co-located cells are treated. Note that the physical situation in which this embodiment can be used is the same as that for the first embodiment, namely the situation of FIG. 3. In the WSC method each cell is considered separately from other cells. Thus, the number of preliminary location estimates is equal to the number of RTT, TD measurement pairs. The method is implemented as follows.

Firstly, a distance estimate for each of the serving cells is obtained using the distance estimation equipment of FIG. 1 using RTT, TD measurement pairs formed on each of the three active radio links RL1, RL2, RL3. These distance estimates are the respective radii of the circles labelled 21, 23 and 24 (as before). Note that the circles 21 and 23 are those which were illustrated dotted in the embodiment of FIG. 4.

A separate preliminary single site CI+RTT location estimate is then obtained for each distance estimate, calculated in a polar reference system centred at each cell site. Each preliminary location estimate has a distance from the cell site equal to the distance estimate, and an orientation based on the orientation of the particular antenna for that radio link (unless more accurate direction information is available). The preliminary location estimates are labelled Est 1, Est 2 and Est 3 in FIG. 5. The antenna orientations can be established using the single site CI+RTT location method.

The final location estimate which is labelled EST WSC is the weighted mass centre of the preliminary location estimates Est 1, Est 2, Est 3. Obtaining the weighted mass centre, and the weighting values is the same as for the WSS method described above.

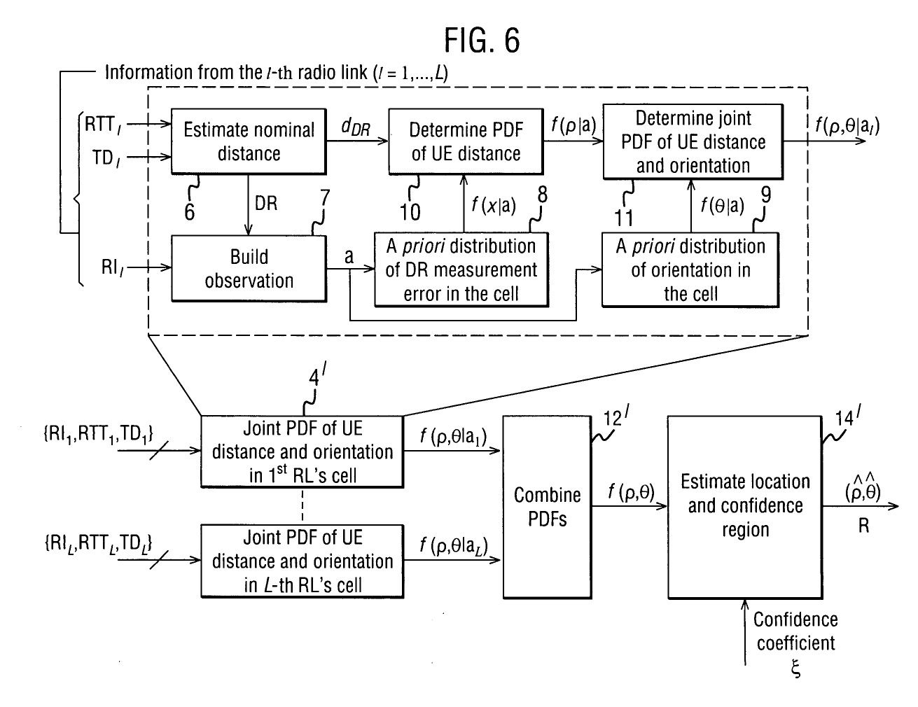

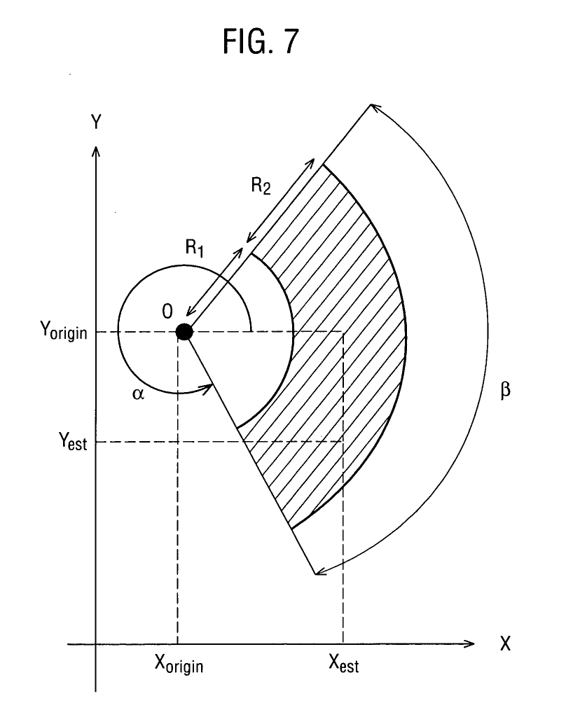

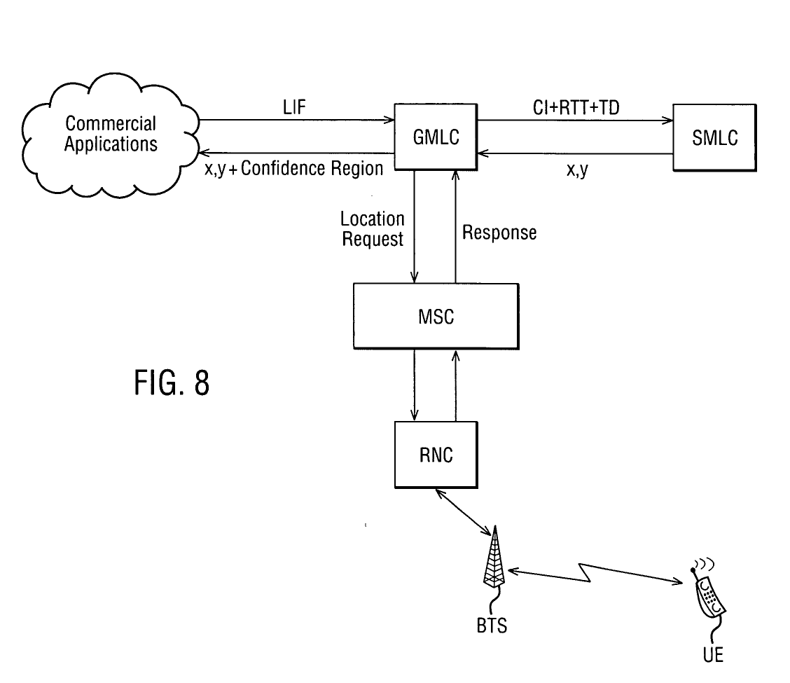

In the above methods, reference is made to a CI+RTT location method. One example of such location method will now be described with reference to FIG. 6. The aim of the method is to estimate the UE geographical coordinates and a confidence region where the true UE location is supposedly located with a given degree of confidence \mathring{5}. The estimated UE coordinates are distance \mathring{8} and orientation [symbol] of the UE from the serving site, represented in the polar reference system. Note that \mathring{8} in FIG. 6 corresponds to d_{EST} in FIG. 1. In the following, there is some duplicate description relating to the distance estimation already discussed above, but in this case there is no discussion of how to deal with multiple sites. Note too that like numerals in FIG. 6 denote like parts in FIG. 1.

The estimates are obtained from a probability distribution of the UE geographical location, which is determined by combining observations and a-priori statistical information. A-priori information includes statistical information about the accuracy of DR as a distance measurement and distribution of the UE orientation within cells border.

Referring to FIG. 6, the location procedure can be seen as a combination of different processing steps, briefly described in the following. The quantization rules at the basis of RTT and Rx−Tx Tim Difference definition in UMTS technical specifications, are used to calculate from each {RTT,TD} pair a Double Range Value, DR, and Double Range distance estimate, d_{DR} in block 6. The Double Range is an integer number indicatively equal to the difference RTT-TD; thus it represents an estimate of twice the absolute distance between target UE and (co-located) cells providing the active radio link.

As a result of the nominal distance estimation, the observation a=[RI,DR] (block 7) becomes available. RI is a radio link identifier, for example a cell identifier CI, providing network data.

For example, radio network data for all cells having an active radio link with the user equipment of interest, can include the following:
antenna coordinates
bearing of the node B's antenna measured clockwise from x-axis in radian [symbol]
half power beam width (HPBW) of the node B's antenna, [symbol]
R_{F} the maximum front radius to the service cell
R_{B} the maximum back radius to the service cell

The Double Range distance estimate is a raw conversion of RTT and TD, reported from UMTS network elements, in a distance estimate. This conversion does not take into account effects of measurement process impairments (multipath and non-line-of-sight propagation over the mobile radio channel, measurement errors, quantization error, etc.) that contribute determining the so-called Double range measurement error, [symbol] =\mathring{8}−d_{DR}, as defined as difference between the exact distance between UE and node B, \mathring{8}, and Double Range distance estimate, d_{DR}. One way to take into account the DR measurement error, that has proved to be very successful in GSM applications, is to supply the location algorithms with a-priori information describing the statistical behaviour of Double Range measurement error, [symbol] as in block 8.

The behaviour of [symbol] depends on many factors, among them environment and distance between UE and node B. For this reason, the PDF of [symbol] conditioned by the observation, f( [symbol] a), is used as a-priori PDF from which the statistical behaviour of the UE distance from the serving site is derived. Once the PDF f( [symbol] |a) is available, the DR distance estimate, d_{DR}, is used to obtain the probability density function (PDF) (block 10) of the UE distance in the cell providing the active radio link, f(\mathring{8}|a).

An analogous but simpler procedure is used to determine the PDF of the UE orientation in the cell providing the active radio link, f( [symbol] |a). The additional simplicity is due to the fact that an orientation measurement is not available, thus statistical distribution of the UE angular distribution can be defined only by using a-priori cell-based orientation information (block 9) such as cell orientation, width, etc.

The PDFs of distance conditioned by the observation and of orientation conditioned by the observations are then combined with each other (block 11) to determine the joint PDF of UE distance and orientation within the cell providing each active radio link f(\mathring{8}, [symbol] a). The PDFs available at this stage describe the geographical distribution of users within the borders of each single cell served by node B providing each active radio link.

Once the joint PDFs of distance and orientation within all cells providing active radio links are available (blocks 4′) they are combined (block 12′) to determine the final joint PDF of distance and orientation, f(\mathring{8}, [symbol] ). Such distribution includes all information gathered from observations (radio link identifiers and measurements) and a-priori statistics; thus it can be finally used to estimate UE coordinates (\hat{ρ}, \hat{θ}) and confidence region R (block 14′). The priming of blocks 4′, 12′, 14′ denotes that they are equivalent to blocks 4, 12 and 14 of FIG. 1, but providing a more complex function.

Thus, the CI+RTT location algorithm provides as outputs:
location calculation results being a set of parameters identifying the coordinates of a location estimate and the parameters of a certain confidence region (a geographical region where the exact UE location is estimated to be with a certain probability)
QoS data which is an indication of whether the location calculation results met the accuracy requirements set in the input quality of service parameters.

The CI+RTT location method involves the two main steps of:
1. estimating the location of the UE in terms of x-y coordinates and
2. calculating a confidence region for this location estimate.

A confidence region is a geographical region where the exact UE location is estimated to be with a given probability, referred to as the confidence coefficient 0<ξ≦1.

The location calculation method is implemented by location calculation algorithms. Two classes of location calculation algorithms are used:
Location Estimate Calculation Algorithms to implement step 1
Confidence Region Calculation Algorithms to implement step 2

The combination of location estimate and confidence region parameters is referred to as “shape”. The shape definitions supported by the location calculation algorithms described above are:
(i) Point Shape (i.e. including only the location estimate)
(ii) Point with Uncertainty Ellipse Shape (where the confidence region is an ellipse)
(iii) Point with Uncertainty Polygon Shape (where the confidence region is a polygon)
(iv) Point with Uncertainty Arc Shape (where the confidence region is a circular arc)

The only confidence region which will be described herein is the Arc-Shape shown in FIG. 7.

This has the following features:
Coordinates of a location estimate (\hat{x}, ŷ)
Coordinates of an origin xₒ and yₒ
Inner radius R1 and uncertainty radius R2
Offset (orientation) angle a and included angle β
Confidence coefficient value ξ

In the context of the Single-Site CI+RTT method, the polar coordinates can be used to introduce the following formal definition of R:
Pr((\mathring{8}, [symbol] ) [symbol] R|a₁, . . . , a_{L})=\mathring{5}

The Arc is the “natural” shape for the Single-Site CI+RTT confidence region. The origin of the arc is at the antenna coordinates, common to all cells providing an active radio link to the UE being located:

$$\{ \frac{{x}_{0} = {x}_{S}}{{y}_{0} = {y}_{S}}$$

Inner radius R₁, uncertainty radius R₂, offset angle [symbol] and included angle [symbol] (see FIG. 7) are calculated by means of the above that, when the confidence region is arc shaped and the PDFs of interest are not conditioned by the observations, can be rewritten as:

$$\begin{matrix}Pr ( ( ρ , θ ) ɛ R ) = \int {\int }_{R} f ( ρ , θ ) ⅆ ρ ⅆ θ \\ = {\int }_{α}^{α = β} ⅆ θ {\int }_{{R}_{1}}^{{R}_{1} + R} f ( ρ , θ ) ⅆ p \\ = ξ\end{matrix}$$

The total probability theorem can be invoked to write f(ρ,θ) as:

$$f ( ρ , θ ) = {\sum }_{m = 1}^{M} {p}_{m} f ( ρ , θ \vert {a}_{m} )$$

hence

$$Pr ( ( ρ , θ ) ɛ R ) = {\int }_{α}^{α + β} ⅆ θ {\int }_{{R}_{1}}^{{R}_{1} + {R}_{2}} [ {\sum }_{m + 1}^{M} {p}_{m} f ( ρ , θ \vert {a}_{m} ) ] ⅆ ρ$$

The confidence region parameters R₁,R₂, [symbol] and [symbol] can be uniquely determined if appropriate additional constraints are introduced, according to requirements of a particular implementation.

FIG. 7 is a schematic diagram of the architecture of a network to illustrate where the location methods described above are implemented. A single base station BTS is shown, which can for example be the base station at site A or site B. In fact, base stations at both site A and site B will be in communication with a radio network controller RNC as illustrated for the single base station in FIG. 7. The radio network controller is in communication with a mobile switching MSC which is in turn in communication with a gateway mobile location center GMLC. The gateway mobile location center can receive an LIF (Location Interoperability Forum) request from commercial applications being implemented in the network. The gateway mobile location center dispatches a location request to the mobile switching center which in turn contacts the radio network controller to obtain the necessary network data and return it to the mobile switching center. A response is thus returned to the gateway mobile location center which supplies CI+RTT, TD pairs to a serving mobile location center SMLC. The location methods described hereinabove are implemented at the serving mobile location center and the x, y data is returned to the gateway mobile location center. The gateway mobile location center returns this x, y data together with the confidence region to the commercial application which requested the location data.

Alternatively, the location methods can be implemented at the RNC or in a stand-alone module elsewhere in the network.

1. A method of generating a location estimate for a mobile station in a wireless communications network, the method comprising:
receiving first measurement data relating to at least one radio link between a mobile station and a first site;
using said first measurement data in a location calculation method with radio network data to provide a first preliminary location estimate;
receiving second measurement data relating to at least one radio link between the mobile station and a second site;
using said second measurement data in the location calculation method with the radio network data to provide a second preliminary location estimate; and
determining a location estimate as a weighted mass center of the first and second preliminary location estimates.

2. The method according to claim 1, further comprising:
determining the weighted mass center by a method including;
weighting the first preliminary location estimate with a first weighting value,
weighting the second preliminary location estimate with a second weighting value, and
determining a mass center of a thus weighted first preliminary location estimate and of a thus weighted second preliminary location estimate.

3. The method according to claim 2, wherein determining the weighted mass center comprises weighting the first and second preliminary location estimates with the first and second weighting values, and wherein the first and second weighting values are substantially equal to each other.

4. The method according to claim 1, further comprising:
generating, using the location calculation method, a confidence region of a predetermined shape representing a geographical region where the mobile station is estimated to be located with a certain probability.

5. The method according to claim 4, further comprising:
generating the weighted mass center by applying a first weighting value to the first preliminary location estimate;
applying a second weighting value to the second preliminary location estimate; and
obtaining the mass center of the first and second weighted preliminary location estimates,
wherein the first and second weighting values represent an inverse of an area of the shape of the confidence region generated by the location calculation method.

6. The method according to claim 1, further comprising:
supporting a plurality of cells with the first site; and
relating radio links of at least two of said cells with the first measurement data,
wherein providing the first preliminary location estimate comprises generating a single first distance estimate using the first measurement data of the radio links of the at least two of said cells, and
wherein providing the second preliminary location estimate comprises generating a second distance estimate using the second measurement data.

7. The method according to claim 6, further comprising the step of determining the weighted mass centre by weighting the first and second preliminary location estimates with first and second weighting values that are related to the first and second distance estimates, respectively.

8. The method according to claim 1, wherein the first site supports at least first and second located cells, and wherein the first measurement data relates to a first radio link from the first located cell, and further measurement data is received which relates to a second link from the second located cell, the method further comprising:
using the further measurement data in the location calculation method with radio network data to provide a further preliminary location estimate which is used with the first and second preliminary location estimates to generate the weighted mass center of a location estimate of the mobile station.

9. The method according to claim 8, wherein using said first and said further measurement data to provide said first and second preliminary location estimates comprises generating respective distance estimates.

10. A network entity in a cellular communications network, wherein the network entity is configured to generate a location estimate for a mobile station in the network, the network entity comprising:
implementing means for implementing a location calculation method using measurement data relating to radio links between a mobile station and respective first and second sites and radio network data to provide respective first and second preliminary location estimates; and
first determining means for determining a location estimate as a weighted mass center of the first and second preliminary location estimates.

11. The network entity according to claim 10, further comprising:
generating means for generating first and second weighting values for respectively weighting the first and second preliminary location estimates.

12. The network entity according to claim 11, wherein the generating means comprises second determining means for determining a confidence region of a predetermined shape representing a geographical region where the mobile station is estimated to be located with a certain probability, and using an area of said confidence region to determine the first and second weighting values.

13. A radio network controller in a cellular communications network, wherein the radio network controller is configured to generate a location estimate for a mobile station in the network, the radio network controller comprising:
implementing means for implementing a location calculation method using measurement data relating to radio links between a mobile station and respective first and second sites and radio network data to provide respective first and second preliminary location estimates; and
first determining means for determining a location estimate as a weighted mass center of the first and second preliminary location estimates.

14. A network entity in a cellular communications network, wherein the network entity is configured to generate a location estimate for a mobile station in the network, the network entity comprising:
a first processor configured to implement a location calculation method using measurement data relating to radio links between a mobile station and respective first and second sites and radio network data to provide respective first and second preliminary location estimates; and
a second processor configured to determine a location estimate as a weighted mass center of the first and second preliminary location estimates.
